(19) United States
(12) Patent Application Publication
(10) Pub. No.: US 2024/0274814 A1
(43) Pub. Date: Aug. 15, 2024

(54) POSITIVE ELECTRODE ACTIVE MATERIAL, POSITIVE ELECTRODE, SOLID-STATE BATTERY, AND METHOD OF MANUFACTURING POSITIVE ELECTRODE ACTIVE MATERIAL

(71) Applicant: TOYOTA JIDOSHA KABUSHIKI KAISHA, Toyota-shi (JP)

(72) Inventor: Issei SUGIYAMA, Susono-shi (JP)

(73) Assignee: TOYOTA JIDOSHA KABUSHIKI KAISHA, Toyota-shi (JP)

(21) Appl. No.: 18/406,266

(22) Filed: Jan. 8, 2024

(30) Foreign Application Priority Data
Feb. 6, 2023 (JP) 2023-016414

(51) Int. Cl. H01M 4/525; H01M 4/505; H01M 4/88; H01M 10/052

(52) U.S. Cl. CPC H01M 4/525; H01M 4/505; H01M 4/8882; H01M 10/052; H01M 2004/028

(57) ABSTRACT

There are provided a positive electrode active material at which an oxygen 1s X-ray photoelectron spectroscopy spectrum obtained by X-ray photoelectron spectroscopy measurement satisfies the following condition 1 or the following condition 2:
condition 1: a peak top does not exist in a region in which a binding energy is from 525 eV to less than 531 eV, and a peak top exists in a region in which the binding energy is from 531 eV to 538 eV; or
condition 2: a ratio of discharge photoelectron intensity Iₕₑ at a peak top, which exists in a region in which the binding energy is from 531 eV to 538 eV, with respect to discharge photoelectron intensity Iₗₑ at a peak top, which exists in a region in which the binding energy is from 525 eV to less than 531 eV, is 1 or more.

### CROSS-REFERENCE TO RELATED APPLICATION

This application is based on and claims priority under 35 USC 119 from Japanese Patent Application No. 2023-016414 filed on Feb. 6, 2023, the disclosure of which is incorporated by reference herein.

### BACKGROUND

### Technical Field

The present disclosure relates to a positive electrode active material, a positive electrode, a solid-state battery, and a method of manufacturing a positive electrode active material.

### Related Art

Positive electrode active materials having at least one type of structure selected from among O2-type structure, T #2-type structure and O6-type structure are stable up to high potentials, and therefore, have a large discharging/charging capacitance in discharging and charging in a high potential region.

Japanese Patent Application Laid-Open (JP-A) No. 2014-186937 proposes “a positive electrode active material for a non-aqueous electrolyte secondary battery that is a positive electrode active material used in a non-aqueous electrolyte secondary battery, and has a layered structure, and contains a lithium-containing transition metal oxide whose main sequence of a transition metal, oxygen and lithium is expressed by an O2-type structure, and the lithium-containing transition metal oxide has Li, Mn and element M in a lithium-containing transition metal layer in the layered structure, and is expressed by general compositional formula Liₓ [Li_{α}(MnₐM_{b})_{1-α}]O₂ where, in the formula, 0.5<x<1.1, 0.1<α<0.33, 0.67<a<0.97, 0.03<b<0.33, and M includes at least one or more elements selected from the group consisting of Ni, Mg, Ti, Fe, Sn, Zr, Nb, Mo, W and Bi”.

JP-A No. 2010-92824 proposes “a positive electrode active material for a non-aqueous electrolyte secondary battery in which, when potential P(V) of a lithium-containing, layered oxide LiₐN_{ab}M_{c}O_{2±α} belonging to the P6₃mc space group (0.5≤a≤1.3, 0≤b≤0.01, 0.90≤c≤1.10, 0≤α≤0.3, M=at least one element selected from among manganese, cobalt, nickel, iron, aluminum, molybdenum, zirconium and magnesium) is within a range of 4.8≤P≤5.0 (vs. Li/Li+), given that the mol ratios of lithium and M respectively are a and c, the ratio a in a case in which c is converted to 1.0 is in the range of 0.08≤a≤0.12”.

Positive electrode active materials having at least one type of structure selected from among O2-type structure, T #2-type structure and O6-type structure expand and contract due to discharging and charging, and therefore, there are cases in which breakage arises at the positive electrode active material. In such a case, the conduction paths of the electrons are cut, and it is easy for the capacitance maintenance rate after discharging and charging are repeated to decrease.

Thus, a topic that one embodiment of the present disclosure attempts to address is the provision of a positive electrode active material by which there can be obtained a battery whose initial discharge capacitance is high and whose capacitance maintenance rate after discharging and charging are repeated is high.

A topic that another embodiment of the present disclosure attempts to address is the provision of a positive electrode by which there can be obtained a battery whose initial discharge capacitance is high and whose capacitance maintenance rate after discharging and charging are repeated is high.
A topic that yet another embodiment of the present disclosure attempts to address is the provision of a solid-state battery whose initial discharge capacitance is high and whose capacitance maintenance rate after discharging and charging are repeated is high.
A topic that still yet another embodiment of the present disclosure attempts to address is the provision of a method of manufacturing a positive electrode active material by which there can be obtained a battery whose initial discharge capacitance is high and whose capacitance maintenance rate after discharging and charging are repeated is high.

Means for addressing the above-described topics include the following means.

<1> A positive electrode active material at which an oxygen 1s X-ray photoelectron spectroscopy spectrum obtained by X-ray photoelectron spectroscopy measurement satisfies the following condition 1 or the following condition 2:
condition 1: a peak top does not exist in a region in which a binding energy is from 525 eV to less than 531 eV, and a peak top exists in a region in which the binding energy is from 531 eV to 538 eV: or,
condition 2: a ratio of discharge photoelectron intensity Iₕₑ at a peak top, which exists in a region in which the binding energy is from 531 eV to 538 eV, with respect to discharge photoelectron intensity Iₗₑ at a peak top, which exists in a region in which the binding energy is from 525 eV to less than 531 eV, is 1 or more.
   <2> The positive electrode active material of <1> that is a compound expressed by the following formula 1.

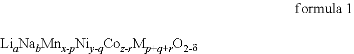

(In formula 1, a, b, x, y, z, p, q, r and δ are numbers that satisfy 0≤ a≤1, 0≤b≤0.05, x+y+z=1, 0≤ p+q+r≤0.20, and 0≤8≤0.3, and M represents at least one selected from the group consisting of B, Mg, Al, K, Ca, Ti, Cr, Ga, Zr, Nb, Mo and W.)
<3> The positive electrode active material of <2>, wherein, in formula 1, M is Al.
<4> A positive electrode having:
a positive electrode layer containing a positive electrode active material; and
a positive electrode collector,
wherein, after the positive electrode is placed at a battery and discharging and charging are carried out, kink bands are formed in the positive electrode active material in 10% or more of the entire positive electrode active material.
   <5> The positive electrode of <4>, wherein a content of the positive electrode active material is 70 mass % or more with respect to the entire positive electrode layer.
   <6> The positive electrode of <4> containing the positive electrode active material of any one of <1> through <3>.
   <7> A solid-state battery having the positive electrode of any one of <4> through <6>.
   <8> A method of manufacturing a positive electrode active material, the method having:
heating a compound expressed by the following formula 2 at 400° C. or more and obtaining an Na-doped precursor, or obtaining an Na-doped precursor represented by the following formula 3; and
exchanging Na ions, which are contained in the Na-doped precursor, with Li ions.

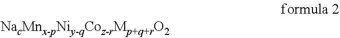

wherein, in formula 2, c, x, y, z, p, q and r are numbers satisfying 0.5≤ c≤0.65, x+y+z=1 and 0≤ p+q+r≤0.20, and M represents at least one selected from the group consisting of Li, B, Mg, Al, K, Ca, Ti, Cr, Ga, Zr, Nb, Mo and W; and

Na_{c}Mnₓ₋ₚNi_{y-q}Co_{z-r}Al_{p+q+r}O₂ formula 3:

wherein, in formula 3, c, x, y, z, p, q and r are numbers satisfying 0.5≤ c≤0.65, x+y+z=1, and 0.05≤ p+q+r≤0.20.

In accordance with an embodiment of the present disclosure, there is provided a positive electrode active material by which there can be obtained a battery whose initial discharge capacitance is high and whose capacitance maintenance rate after discharging and charging are repeated is high.

In accordance with another embodiment of the present disclosure, there is provided a positive electrode by which there can be obtained a battery whose initial discharge capacitance is high and whose capacitance maintenance rate after discharging and charging are repeated is high.
In accordance with yet another embodiment of the present disclosure, there is provided a solid-state battery whose initial discharge capacitance is high and whose capacitance maintenance rate after discharging and charging are repeated is high.
In accordance with still yet another embodiment of the present disclosure, there is provided a method of manufacturing a positive electrode active material by which there can be obtained a battery whose initial discharge capacitance is high and whose capacitance maintenance rate after discharging and charging are repeated is high.

### BRIEF DESCRIPTION OF THE DRAWINGS

Exemplary embodiments of the present invention will be described in detail based on the following FIGURE, wherein:

FIG. 1 is a schematic sectional view illustrating an example of a solid-state battery.

### DETAILED DESCRIPTION

Embodiments that are examples of the present disclosure are described hereinafter. The description thereof and the Examples are for exemplifying embodiments, and are not intended to limit the scope of the invention.

In numerical value ranges that are expressed in a stepwise manner in the present specification, the upper limit value or the lower limit value listed in a numerical value range may be substituted by the upper limit value or the lower limit value of another numerical value range that is expressed in a stepwise manner. Further, in the numerical value ranges put forth in the present specification, the upper limit value or the lower limit value of a numerical value range may be substituted by a value shown in the Examples.

Each component may include plural types of the corresponding material.

When amounts of respective components in a composition are stated, if there are plural types of materials corresponding to a component in a composition, the amount means the total amount of the plural types of materials existing in the composition, unless otherwise stated. “Step” is not only an independent step and includes steps that, in a case in which that step cannot be clearly distinguished from another step, achieve the intended object of that step.

### <Positive Electrode Active Material>

The positive electrode active material relating to the present disclosure is a positive electrode active material at which the oxygen 1s X-ray photoelectron spectroscopy spectrum obtained by X-ray photoelectron spectroscopy measurement satisfies the following condition 1 or the following condition 2.
condition 1: A peak top does not exist in a region in which the binding energy is from 525 eV to less than 531 eV, and a peak top exists in a region in which the binding energy is from 531 eV to 538 eV.
condition 2: The ratio of discharge photoelectron intensity Iₕₑ at a peak top, which exists in a region in which the binding energy is from 531 eV to 538 eV, with respect to discharge photoelectron intensity Iₗₑ at a peak top, which exists in a region in which the binding energy is from 525 eV to less than 531 eV, is 1 or more.

Due to the above structure, the positive electrode active material relating to the present disclosure is a positive electrode active material by which there can be obtained a battery whose initial discharge capacitance is high and whose capacitance maintenance rate after discharging and charging are repeated is high. The reason for this is assumed to be as follows.

At the positive electrode active material at which the oxygen 1s X-ray photoelectron spectroscopy spectrum obtained by X-ray photoelectron spectroscopy measurement satisfies above condition 1 or above condition 2, it is easy for kink bands to form in a case in which discharging and charging are carried out. Therefore, even in a case in which the positive electrode active material expands and contracts due to discharging and charging, and breakage arises thereat, it is difficult for the conduction paths to be cut, and decreasing of the capacitance maintenance rate after discharging and charging are repeated is suppressed, and the initial discharge capacitance is high.

### (Oxygen 1s X-Ray Photoelectron Spectroscopy Spectrum)

At the positive electrode active material relating to the present disclosure, the oxygen 1s X-ray photoelectron spectroscopy spectrum obtained by X-ray photoelectron spectroscopy measurement satisfies the following condition 1 or the following condition 2.
condition 1: A peak top does not exist in a region in which the binding energy is from 525 eV to less than 531 eV, and a peak top exists in a region in which the binding energy is from 531 eV to 538 eV.
condition 2: The ratio of the discharge photoelectron intensity Iₕₑ at a peak top, which exists in a region in which the binding energy is from 531 eV to 538 eV, with respect to the discharge photoelectron intensity Iₗₑ at a peak top, which exists in a region in which the binding energy is from 525 eV to less than 531 eV, is 1 or more.

The oxygen 1s X-ray photoelectron spectroscopy spectrum is obtained by X-ray photoelectron spectroscopy measurement. For example, the PHI VersaProbe manufactured by ULVEC-PHI Incorporated can be used as the X-ray photoelectron spectroscopy measuring device.

The processes of obtaining the oxygen 1s X-ray photoelectron spectroscopy spectrum are described hereinafter.
In a state in which the potential vs. Li is controlled to be 3.0 V or less, a positive electrode that contains a positive electrode active material (i.e., a structure that includes a positive electrode layer and a positive electrode collector) is removed from a battery. With, of the positive electrode, the positive electrode layer that contains the positive electrode active material being set as the top surface, the surface of the positive electrode layer is spattered by a method such as argon spattering or the like to 100 nm or more in the thickness direction.
In the spattered region, X-ray photoelectron spectroscopy measurement is carried out in the range in which the binding energy is from 525 eV to 538 eV, and the oxygen 1s X-ray photoelectron spectroscopy spectrum is obtained. Simultaneously, X-ray photoelectron spectroscopy is carried out in a range that includes a range in which the binding energy is from 280 eV to less than 295 eV, and all of the spectra are shifted such that the spectrum that exhibits the largest peak among the obtained peaks becomes 284.5 eV.
Among the obtained X-ray photoelectron spectroscopy spectra, it is confirmed whether or not there is a peak in the region in which the binding energy is from 525 eV to less than 531 eV, and in the region in which the binding energy is from 531 eV to 538 eV.
Here, it is deemed that above condition 1 is satisfied in a case in which there does not exist a peak top in the region in which the binding energy is from 525 eV to less than 531 eV, and there does exist a peak top in the region in which the binding energy is from 531 eV to 538 eV.
Further, in a case in which there is a peak in both the region in which the binding energy is from 525 eV to less than 531 eV and in the region in which the binding energy is from 531 eV to 538 eV, the discharge photoelectron intensity Iₗₑ at the peak top that exists in the region in which the binding energy is from 525 eV to less than 531 eV, and the discharge photoelectron intensity Iₕₑ at the peak top that exists in the region in which the binding energy is from 531 eV to 538 eV, are respectively calculated. Then, the value of ratio (Iₕₑ/Iₗₑ) of the discharge photoelectron intensity Iₕₑ with respect to the discharge photoelectron intensity Iₗₑ is calculated, and, in a case in which this value is 1 or more, it is deemed that above condition 2 is satisfied.

### (Compositional Formula of Positive Electrode Active Material)

From the standpoint of the initial discharge capacitance and the capacitance maintenance rate, it is preferable that the positive electrode active material is a compound expressed by the following formula 1.

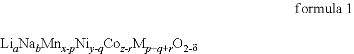

In formula 1, a, b, x, y, z, p, q, r and δ are numbers that satisfy 0≤ a≤1, 0≤b≤0.05, x+y+z=1, 0≤ p+q+r≤0.20, and 0≤8≤0.3.
M represents at least one selected from the group consisting of B, Mg, Al, K, Ca, Ti, Cr, Ga, Zr, Nb, Mo and W.

x is preferably a number satisfying 0≤x≤1, and more preferably a number satisfying 0.1≤x≤1.

y is preferably a number satisfying 0≤y≤0.5, and more preferably a number satisfying 0≤y≤0.33.
z is preferably a number satisfying 0≤z≤1, and more preferably a number satisfying 0≤z≤0.67.
p is preferably a number satisfying 0≤p≤0.10.
q is preferably a number satisfying 0≤q≤0.10.
r is preferably a number satisfying 0≤r≤0.10.

Here, in above formula 1, if M is K, it is preferable that 3≤4x+2y+3z−3p−q−2r≤3.5 is satisfied.

In formula 1, if M is at least one selected from the group consisting of Mg and Ca, it is preferable that 3≤4x+2y+3z−2p−r≤3.5 is satisfied.
In formula 1, if M is at least one selected from the group consisting of B, Al, Cr and Ga, it is preferable that 3≤4x+2y+3z−p+q≤3.5 is satisfied.
In formula 1, if M is at least one selected from the group consisting of Ti, Zr and Mo, it is preferable that 3≤4x+2y+3z+2q+r≤3.5 is satisfied.
In formula 1, if M is Nb, it is preferable that 3≤4x+2y+3z+p+3q+2r≤3.5 is satisfied.
In formula 1, if M is W, it is preferable that 3≤4x+2y+3z+2p+4q+3r≤3.5 is satisfied.
In formula 1, if p+q+r=0, it is preferable that 0.02≤8≤0.3 is satisfied.

From the standpoint of the initial discharge capacitance and the capacitance maintenance rate, it is preferable that, in above formula 1, M is Al.

By making M be Al in above formula 1, it is easy for kink bands to form accompanying discharging and charging.

Specific examples of the positive electrode active material relating to the present disclosure are
Li_{0.70}Na_{0.00}Mn_{0.50}Ni_{0.20}Co_{0.30}O_{1.98}, Li_{0.70}Na_{0.00}Mn_{0.50}Ni_{0.20}Co_{0.30}O_{1.90},
Li_{0.70}Na_{0.00}Mn_{0.50}Ni_{0.20}Co_{0.30}O_{1.80}, Li_{0.70}Na_{0.00}Mn_{0.50}Ni_{0.20}Co_{0.30}O_{1.70},
Li_{0.70}Na_{0.05}Mn_{0.50}Ni_{0.20}Co_{0.30}O_{1.90}, Li_{0.70}Na_{0.00}Mn_{0.67}Ni_{0.33}O_{1.90},
Li_{0.70}Na_{0.00}Mn_{0.67}Ni_{0.33}O_{1.80}, Li_{0.70}Na_{0.00}Mn_{0.50}Ni_{0.20}Co_{0.20}Al_{0.10}O₂,
Li_{0.60}Na_{0.00}Mn_{0.50}Ni_{0.20}Co_{0.20}Al_{0.10}O₂, Li_{0.70}Na_{0.05}Mn_{0.50}Ni_{0.20}Co_{0.20}Al_{0.10}O₂,
Li_{0.70}Na_{0.00}Mn_{0.50}Ni_{0.20}Co_{0.10}Al_{0.20}O₂, Li_{0.70}Na_{0.00}Mn_{0.45}Ni_{0.15}Co_{0.30}Al_{0.10}O₂,
Li_{0.70}Na_{0.00}Mn_{0.50}Ni_{0.20}Co_{0.25}Al_{0.05}O₂, and the like.

### <Method of Manufacturing Positive Electrode Active Material>

The method of manufacturing a positive electrode active material relating to the present disclosure includes: a first step that is a step of heating a compound expressed by the following formula 2 at 400° C. or more and obtaining an Na-doped precursor, or is a step of obtaining an Na-doped precursor expressed by the following formula 3; and a step (ion exchanging step) of exchanging the Na ions, which are contained in the Na-doped precursor, with Li ions.

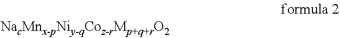

In above formula 2, c, x, y, z, p, q and r are numbers satisfying 0.5≤ c≤0.65, x+y+z=1 and 0≤ p+q+r≤0.20.
M represents at least one selected from the group consisting of Li, B, Mg, Al, K, Ca, Ti, Cr, Ga, Zr, Nb, Mo and W.

x is preferably a number satisfying 0≤x≤1, and more preferably a number satisfying 0.1≤x≤1.

y is preferably a number satisfying 0≤y≤0.5, and more preferably a number satisfying 0≤ y≤0.33.
z is preferably a number satisfying 0≤z≤1, and more preferably a number satisfying 0≤z≤ 0.67.
p is preferably a number satisfying 0≤ p≤0.10.
q is preferably a number satisfying 0≤ q≤0.10.
r is preferably a number satisfying 0≤ r≤0.10.

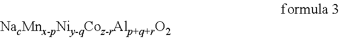

In above formula 3, c, x, y, z, p, q and r are numbers satisfying 0.5≤ c≤0.65, x+y+z=1, and 0.05≤ p+q+r≤0.20.

x is preferably a number satisfying 0≤x≤1, and more preferably a number satisfying 0.1≤x≤1.

y is preferably a number satisfying 0≤y≤0.5, and more preferably a number satisfying 0≤ y≤0.33.
z is preferably a number satisfying 0≤z≤1, and more preferably a number satisfying 0≤z≤ 0.67.
p is preferably a number satisfying 0≤ p≤0.10.
q is preferably a number satisfying 0≤ q≤0.10.
r is preferably a number satisfying 0≤ r≤0.10.
p and q are 0≤p=q≤0.05.

### (Step of Synthesizing Compound Expressed by Formula 2)

In a case in which the first step is a step of heating a compound expressed by above formula 2 at 400° C. or more and obtaining an Na-doped precursor, the method of manufacturing a positive electrode active material relating to the present disclosure may, as needed, include a step of synthesizing a compound expressed by above formula 2.
Compounds expressed by above formula 2 are synthesized in accordance with known methods.

Specific examples of compounds expressed by above formula 2 are
Na_{0.70}Mn_{0.5}Ni_{0.2}Co_{0.3}O₂, Na_{0.80}Mn_{0.5}Ni_{0.2}Co_{0.3}O₂, Na_{0.70}Mn_{0.67}Ni_{0.33}O₂,
Na_{0.70}Mn_{0.40}Ni_{0.20}Co_{0.30}Cr_{0.10}O₂, Na_{0.70}Mn_{0.50}Ni_{0.10}Co_{0.30}Mg_{0.10}O₂, and the like.

### (First Step)

The first step is a step of heating a compound expressed by above formula 2 at 400° C. or more and obtaining an Na-doped precursor, or is a step of obtaining an Na-doped precursor expressed by above formula 3.
It is easy to obtain the positive electrode active material relating to the present disclosure by this step.

### —Step of Heating a Compound Expressed by Above Formula 2 at 400° C. or More and Obtaining an Na-Doped Precursor—

First, a step (oxygen vacancy introducing step) of heating a compound expressed by above formula 2 at 400° C. or more and obtaining an Na-doped precursor is described.
The oxygen vacancy introducing step is preferably carried out at 100 Pa or less, and more preferably carried out at 10 Pa or less, and even more preferably carried out at 1 Pa or less.

The pressure in the oxygen vacancy introducing step is measured by using a pressure gauge.

A Pirani gauge and an ionization gauge are examples of the pressure gauge.

The oxygen vacancy introducing step is preferably carried out at 400° C. or more and 600° C. or less, and more preferably carried out at 400° C. or more and 500° C. or less, and even more preferably carried out at 400° C. or more and 450° C. or less.

The temperature in the oxygen vacancy introducing step is measured by using a thermometer.

The oxygen vacancy introducing step may be carried out in air, or may be carried out in a mixed gas of air and hydrogen.

In a case in which the oxygen vacancy introducing step is carried out in a mixed gas of air and hydrogen, the content of air with respect to the volume of the entire mixed gas is preferably 80 volume % or more and 99 volume % or less, and more preferably 90 volume % or more and 95 volume % or less.

The oxygen vacancy introducing step is preferably carried out for 10 hours or more and 20 hours or less, and more preferably carried out for 11 hours or more and 15 hours or less, and even more preferably carried out for 12 hours or more and 13 hours or less.

### —Step of Obtaining an Na-Doped Precursor Expressed by Above Formula 3—

Next, a step (Na-doped precursor direct synthesizing step) of obtaining an Na-doped precursor expressed by above formula 3 is described.
The present step is a step of obtaining a compound expressed by above formula 3. The obtained compound is an Na-doped precursor.
Compounds expressed by above formula 3 are synthesized in accordance with known methods.

Specific examples of compounds expressed by above formula 3 are
Na_{0.70}Mn_{0.5}Ni_{0.2}Co_{0.3}O₂, Na_{0.70}Mn_{0.50}Ni_{0.20}Co_{0.20}Al_{0.10}O₂,
Na_{0.70}Mn_{0.50}Ni_{0.20}Co_{0.20}Al_{0.10}O₂, Na_{0.75}Mn_{0.50}Ni_{0.20}Co_{0.20}Al_{0.10}O₂,
Na_{0.70}Mn_{0.50}Ni_{0.20}Co_{0.10}Al_{0.20}O₂, Na_{0.70}Mn_{0.45}Ni_{0.15}Co_{0.30}Al_{0.10}O₂,
Na_{0.70}Mn_{0.50}Ni_{0.20}Co_{0.25}Al_{0.05}O₂, and the like.

### (Ion Exchanging Step)

The ion exchanging step is a step of exchanging the Na ions, which are contained in the Na-doped precursor, with Li ions.
The ion exchanging of the Na-doped precursor can utilize a molten salt matrix in which lithium nitrate and lithium chloride are mixed together. For example, it is preferable to mix an Na-doped precursor in a molten salt matrix and carry out heating.
The temperature at the time of ion exchanging is preferably a range of greater than or equal to the temperature at which the molten salt matrix melts and less than 320° C.

### <Positive Electrode>

The positive electrode relating to the present disclosure has a positive electrode layer containing a positive electrode active material, and a positive electrode collector. After the positive electrode is placed at a battery and discharging and charging are carried out, kink bands are formed in the positive electrode active material in 10% or more of the entire positive electrode active material.

Owing to the above-described structure, the positive electrode relating to the present disclosure is a positive electrode by which there can be obtained a battery whose initial discharge capacitance is high and whose capacitance maintenance rate after discharging and charging are repeated is high. The reason for this is assumed to be as follows.

After the electrode relating to the present disclosure is placed at a battery and discharging and charging are carried out, kink bands are formed in the positive electrode active material in 10% or more of the entire positive electrode active material. Therefore, even if the positive electrode active material expands and contracts due to discharging and charging, and breakage arises thereat, it is difficult for the conduction paths to be cut, and decreasing of the capacitance maintenance rate after discharging and charging are repeated is suppressed, and the initial discharge capacitance is high.

### (Positive Electrode Layer)

The positive electrode layer contains a positive electrode active material, and may contain a conduction assistant, a solid electrolyte, a binder, and other components as needed.

### —Positive Electrode Active Material—

From the standpoint of the initial discharge capacitance and the capacitance maintenance rate, it is preferable that the above-described positive electrode active material relating to the present disclosure be contained as the positive electrode active material.

The positive electrode layer relating to the present disclosure may contain a positive electrode active material other than the positive electrode active material relating to the present disclosure.

It is preferable that a lithium composite oxide be contained as the other positive electrode active material. The lithium composite oxide may contain at least one selected from the group consisting of F, Cl, N, S, Br and I. Further, the lithium composite oxide may have a crystal structure belonging to at least one space group selected from space groups R-3m, Immm, and P63-mmc (also called P63mc, P6/mmc). In the lithium composite oxide, the main sequence of a transition metal, oxygen and lithium may be an O2-type structure.

Examples of lithium composite oxides having a crystal structure belonging to R-3m are compounds expressed by LiₓMe_{y}O_{α}X_{β} (Me represents at least one selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si and P, and X represents at least one selected from the group consisting of F, Cl, N, S, Br and I, and 0.5≤x≤1.5, 0.5≤y≤1.0, 1≤ α<2, 0<β≤1 are satisfied).

Examples of lithium composite oxides having a crystal structure belonging to Immm are composite oxides expressed by Liₓ₁M¹A¹₂ (1.5≤x1≤2.3 is satisfied, M¹ includes at least one selected from the group consisting of Ni, Co, Mn, Cu and Fe, A¹ includes at least oxygen, and the ratio of the oxygen contained in A¹ is greater than or equal to 85 atom %) (a specific example is Li₂NiO₂), and composite oxides expressed by Liₓ₁M^{1A}₁₋ₓ₂M^{1B}ₓ₂O_{2-y}A²_{y} (0≤×2≤0.5 and 0≤y≤0.3, at least one of x2 and y is not 0, M^{1A} represents at least one selected from the group consisting of Ni, Co, Mn, Cu and Fe, M^{1B} represents at least one selected from the group consisting of Al, Mg, Sc, Ti, Cr, V, Zn, Ga, Zr, Mo, Nb, Ta and W, and A² represents at least one selected from the group consisting of F, Cl, Br, S and P).

Examples of lithium composite oxides having a crystal structure belonging to P63-mmc are composite oxides expressed by M1ₓM2_{y}O₂ (M1 represents an alkali metal (at least one of Na and K is preferable), M2 represents a transition metal (at least one selected from the group consisting of Mn, Ni, Co and Fe is preferable), and x+y satisfies 0<x+y≤2).

Examples of lithium composite oxides having an O2-type structure are composite oxides expressed by Liₓ[La_{α}(MnₐCO_{b}M_{c})_{1-α}]O₂ (0.5<x<1.1, 0.1<α<0.33, 0.17<a<0.93, 0.03<b<0.50, 0.04<c<0.33, and M represents at least one selected from the group consisting of Ni, Mg, Ti, Fe, Sn, Zr, Nb, Mo, W and Bi). Specific examples are Li_{0.744}[Li_{0.145}Mn_{0.625}Co_{0.115}Ni_{0.115}]O₂ and the like.

A form in which at least a portion of the surface of the positive electrode active material is covered by a sulfide solid electrolyte, an oxide solid electrolyte or a halide solid electrolyte is preferable. Li_{6-(4-x)b}(Ti₁₋ₓAlₓ)_{b}F₆ (0<x<1, 0<b≤1.5) [LTAF electrolyte] is preferable as the halide solid electrolyte that covers at least a portion of the surface of the positive electrode active material.

From the standpoint of the initial discharge capacitance and the capacitance maintenance rate, the content of the positive electrode active material with respect to the entire positive electrode layer is preferably 70 mass % or more, and more preferably 75 mass % or more and 90 mass % or less, and even more preferably 80 mass % or more and 85 mass % or less.

### —Conduction Assistant—

Examples of the conduction assistant are carbon materials, metal materials, and conductive polymer materials. Examples of the carbon materials are carbon black (e.g., acetylene black, furnace black, ketjen black, and the like), filamentous carbon (e.g., vapor grown carbon fibers, carbon nanotubes, carbon nanofibers, and the like), graphite, fluorocarbons, and the like. Examples of the metal materials are metal powders (e.g., aluminum powder and the like), conductive whiskers (e.g., zinc oxide, potassium titanate, and the like), conductive metal oxides (e.g., titanium oxide and the like), and the like. Examples of the conductive polymer materials are polyaniline, polypyrrole, polythiophene, and the like. One type of conduction assistant may be used alone, or two or more types may be used by being mixed together.

### —Solid Electrolyte—

It is preferable that at least one type of solid electrolyte selected from the group of solid electrolytes consisting of sulfide solid electrolytes, oxide solid electrolytes, and halide solid electrolytes is contained as the solid electrolyte.

The sulfide solid electrolyte contains sulfur (S) as the main component that is an anion element, and further, preferably contains, for example, the element Li and element A. Element A is at least one selected from the group consisting of P, As, Sb, Si, Ge, Sn, B, Al, Ga and In. The sulfide solid electrolyte may further contain at least one of O and a halogen element. Examples of the halogen element (X) are F, Cl, Br, I and the like. The composition of the sulfide solid electrolyte is not particularly limited, and examples are xLi₂S·(100−x)P₂S₅ (70≤x≤80) and yLiI·zLiBr·(100−y−z)(xLi₂S·(1−x)P2S₅) (0.7≤x≤0.8, 0≤y≤30, 0≤z≤30). The sulfide solid electrolyte may have the composition expressed by the following general formula (1).

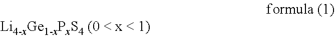

In formula (1), at least a portion of Ge may be substituted by at least one selected from the group consisting of Sb, Si, Sn, B, Al, Ga, In, Ti, Zr, V and Nb. Further, at least a portion of P may be substituted by at least one selected from the group consisting of Sb, Si, Sn, B, Al, Ga, In, Ti, Zr, V and Nb. A portion of Li may be substituted by at least one selected from the group consisting of Na, K, Mg, Ca and Zn. A portion of S may be substituted by a halogen. The halogen is at least one of F, Cl, Br and I.

The oxide solid electrolyte contains oxygen (O) as the main component that is an anion element, and, for example, may contain the element Li and element Q (Q represents at least one of Nb, B, Al, Si, P, Ti, Zr, Mo, W and S). Examples of the oxide solid electrolyte are garnet type solid electrolytes, perovskite type solid electrolytes, NASICON type solid electrolytes, Li—P—O solid electrolytes, Li—B—O solid electrolytes, and the like. Examples of garnet type solid electrolytes are Li₇La₃Zr₂O₁₂, Li₇₋ₓLa₃(Zr₂₋ₓNbₓ)O₁₂ (0≤x≤2), Li₅La₃Nb₂O₁₂, and the like. Examples of perovskite type solid electrolytes are (Li,La)TiO₃, (Li,La)NbO₃, (Li,Sr)(Ta,Zr)O₃ and the like. Examples of NASICON type solid electrolytes are Li(Al,Ti)(PO₄)₃, Li(Al,Ga)(PO₄)₃, and the like. Examples of Li—P—O solid electrolytes are Li₃PO₄ and LIPON (compounds in which some of the O in Li₃PO₄ is substituted with N). Examples of Li—B—O solid electrolytes are Li₃BO₃, compounds in which some of the O in Li₃BO₃ is substituted with C, and the like.

As the halide solid electrolyte, solid electrolytes containing Li, M and X (M represents at least one of Ti, Al and Y, and X represents F, Cl or Br) are suitable. Specifically, Li_{6-3z}Y_{z}X₆ (X represents Cl or Br, and z satisfies 0<z<2) and Li_{6-(4-x)b}(Ti₁₋ₓAlₓ)_{b}F₆ (0<x<1, 0<b≤1.5) are preferable. Among Li_{6-3z}Y₂X₆, from the standpoint of having excellent lithium ion conductivity, Li₃YX₆ (X represents Cl or Br) is more preferable, and Li₃YCl₆ is even more preferable. Further, from standpoints such as, for example, suppressing oxidative decomposition of the sulfide solid electrolyte and the like, it is preferable that Li_{6-(4-x)b}(Ti₁₋ₓAlₓ)_{b}F₆ (0<x<1, 0<b≤1.5) be contained together with a solid electrolyte such as a sulfide solid electrolyte or the like.

### —Binder—

Examples of the binder are vinyl halide resins, rubbers, polyolefin resins, and the like. Examples of vinyl halide resins are polyvinylidene fluoride (PVdF), the copolymer (PVdF-HFP) of polyvinylidene fluoride and hexafluoropropylene, and the like. Examples of polyolefin resins are butadiene rubber (BR), acrylate-butadiene rubber (ABR), styrene-butadiene rubber (SBR), acrylonitrile-butadiene rubber (NBR), butyl rubber (isobutylene-isoprene rubber), and the like. Examples of polyolefin resins are polyethylene, polypropylene, and the like. The binder may be a diene rubber containing a double bond in the main chain, e.g., butadiene rubber in which 30 mol % or more of the entire amount is butadiene.

### —Other Components—

Examples of the other components are oxide solid electrolytes, halide solid electrolytes, thickeners, surfactants, dispersants, wetting agents, antifoaming agents, solvents and the like.

### (Positive Electrode Collector)

The solid-state battery has a positive electrode collector. The positive electrode collector carries out power collection of the positive electrode layer. The positive electrode collector is disposed at a position at an opposite side of the positive electrode layer from the side at which the electrolyte layer (or the separator) is disposed.
Examples of the positive electrode collector are stainless steel, aluminum, copper, nickel, iron, titanium, carbon and the like, and an aluminum alloy foil or an aluminum foil is preferable. The aluminum alloy foil or aluminum foil may be manufactured by using a powder. Examples of the form of the positive electrode collector are the form of a foil and the form of a mesh.
The positive electrode collector may be a structure in which a shock-absorbing layer, an elastic layer or a PTC (Positive Temperature Coefficient) thermistor layer is disposed on the surface of the collector.

### (Kink Bands)

After the positive electrode relating to the present disclosure is placed at a battery and discharging and charging are carried out, kink bands are formed in the positive electrode active material in 10% or more of the entire positive electrode active material.

Here, a “kink band” is a deformed band in which the lattice is formed so as to be bent by 1° or more, and means a band in which respective sides of the kink band (one side and the opposite side with the kink band between) do not have mirror symmetry. In particular, in a positive electrode active material for an Li-ion battery having a layered structure, the kink band is formed as a surface having an angle of 30° or more with respect to (001).

From the standpoint of the initial discharge capacitance and the capacitance maintenance rate, it is preferable that, after the positive electrode relating to the present disclosure is placed at a battery and discharging and charging are carried out, kink bands are formed in the positive electrode active material in 10% or more of the entire positive electrode active material, and more preferable that kink bands are formed in 10% or more and 50% or less of the positive electrode active material, and even more preferable that kink bands are formed in 20% or more and 40% or less of the positive electrode active material.

### Process of Calculating Kink Band Formation Proportion

Here, the formation of kink bands of the positive electrode active material after the positive electrode is disposed at a battery and discharging and charging are carried out, is confirmed from a selected area diffractogram of the positive electrode active material. The selected area diffractogram is obtained by observing the positive electrode active material using a transmission electron microscope. For example, JEM-ARM 200F manufactured by JEOL Ltd. can be used as the transmission electron microscope. The process of calculating the proportion of formation of kink bands of the positive electrode active material after the positive electrode is disposed at a battery and discharging and charging are carried out is described hereinafter.
First, discharging and charging of a battery, which includes the positive electrode that is to be the object of measurement, are carried out. Here, given that discharging and charging are considered to be one cycle, the number of cycles is a maximum of 20 cycles. The discharging and charging conditions are as follows.
discharging conditions: 0.1 C, 2.0 V
charging conditions: 0.1 C, 4.8 V

Next, the positive electrode is removed from the battery at which the discharging and charging were carried out. 100 or more particles of the positive electrode active material contained in the positive electrode layer of the removed electrode are observed by a transmission electron microscope, and a selected area diffractogram is obtained for each of the particles. A total of 100 selected area diffractograms are observed. The number of selected area diffractograms, at which it is observed that there is overlapping of two or more diffractograms of an O2-type structure rotated 1° C. or more, a T #2-type structure rotated 1° C. or more, or an O6-type structure rotated 1° C. or more, is counted. If this number is 10 or more, it is judged that kink bands have formed in the positive electrode active material in 10% or more of the entire positive electrode active material.

### <Solid-State Battery>

The solid-state battery relating to the present disclosure has the positive electrode relating to the present disclosure.
The solid-state battery relating to the present disclosure preferably has a positive electrode, a negative electrode, and an electrolyte layer or a separator disposed between the positive electrode and the negative electrode.
The positive electrode relating to the present disclosure is used as the positive electrode, and the positive electrode has a positive electrode layer and a positive electrode collector. The negative electrode has a negative electrode layer, and, as needed, may have a negative electrode collector.

### (Battery Structure)

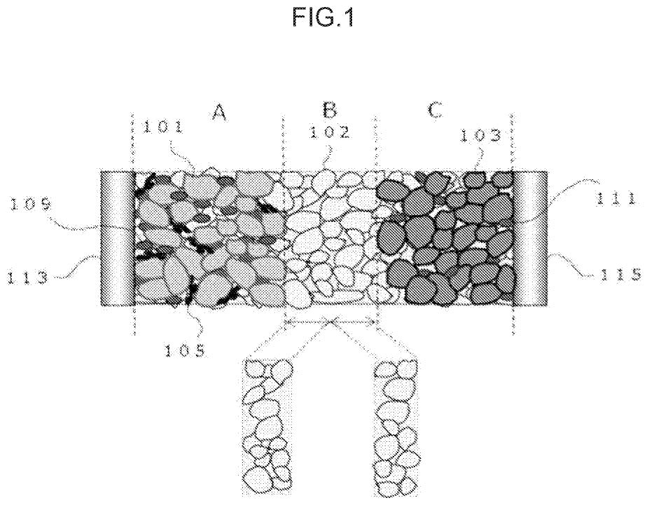

Solid-state batteries include so-called all-solid-state batteries that use an inorganic solid electrolyte as the electrolyte (i.e., in which the content of electrolyte liquid that serves as an electrolyte is less than 5 mass % with respect to the total amount of the electrolyte).
FIG. 1 is a schematic sectional view illustrating an example of a solid-state battery. The solid state battery illustrated in FIG. 1 has a negative electrode including a negative electrode collector 113 and a negative electrode layer A, a solid electrolyte layer B, and a positive electrode including a positive electrode collector 115 and a positive electrode layer C. The negative electrode layer A contains a negative electrode active material 101, a conduction assistant 105, a binder 109 and a solid electrolyte 102. The positive electrode layer C contains a positive electrode active material 103, a binder 111 and a solid electrolyte 102. The solid electrolyte layer B may have a two-layer structure as illustrated in FIG. 1. The solid electrolyte layer B may be a single-layer structure, or may be a multilayer structure of two or more layers.

Given that the set of the positive electrode layer, the solid electrolyte layer and the negative electrode layer is the power generating unit, the solid-state battery may have only one power generating unit or may have two or more power generating units. In a case in which the solid-state battery has two or more power generating units, these power generating units may be connected in series or may be connected in parallel.

The solid-state battery may be structured such that the layer end surfaces (side surfaces) of a layered structure of a positive electrode layer/a solid electrolyte layer/a negative electrode layer are sealed by a resin. The collector of the electrode may be a structure in which a shock-absorbing layer, an elastic layer or a PTC (Positive Temperature Coefficient) thermistor layer is disposed on the surface of the collector.

The shape of the solid-state battery is not particularly limited, and may be, for example, coin-shaped, cylindrical, square, sheet-shaped, button-shaped, flat or layered.

### (Positive Electrode)

The solid-state battery relating to the present disclosure has the positive electrode relating to the present disclosure, and preferable aspects thereof also are the same.

### (Electrolyte Layer and Separator)

The solid-state battery has an electrolyte layer or a separator.

The electrolyte layer may be a layer that contains a solid electrolyte.

If the electrolyte layer is a layer containing a solid electrolyte (a solid electrolyte layer), the solid electrolyte layer preferably contains at least one selected from the group consisting of sulfide solid electrolytes, oxide solid electrolytes and halide solid electrolytes.
Specific examples of the sulfide solid electrolytes, oxide solid electrolytes and halide solid electrolytes are the same as those described above.

The solid electrolyte layer may be a single-layer structure, or may be a multilayer structure of two or more layers.

The solid electrolyte layer may contain a binder, or may not contain a binder. Examples of binders that can be contained in the solid electrolyte layer are the same as those described above.

A porous sheet (film) formed from a resin such as polyethylene (PE), polypropylene (PP), polyester, cellulose, polyamide or the like can be used as the separator.

### (Negative Electrode Layer)

The solid state battery has a negative electrode layer. The negative electrode layer contains a negative electrode active material. The negative electrode layer may, as needed, contain at least one of a solid electrolyte for the negative electrode, a conduction assistant, and a binder. Examples of the negative electrode active material are Li-based active materials such as metallic lithium and the like, carbon-based active materials such as graphite and the like, oxide-based active materials such as lithium titanate and the like, and Si-based active materials such as elemental Si and the like. Examples of the conduction assistant, the solid electrolyte for the negative electrode, and the binder that are used in the negative electrode layer are similar to those exemplified as the conduction assistant contained in the positive electrode layer, the solid electrolyte contained in the solid electrolyte layer, and the binder.

### (Negative Electrode Collector)

The solid-state battery may further have a negative electrode collector. The negative electrode collector carries out power collection of the negative electrode layer. The negative electrode collector is disposed at a position at an opposite side of the negative electrode layer from the side at which the electrolyte layer (or the separator) is disposed.
Examples of the negative electrode collector are stainless steel, aluminum, copper, nickel, iron, titanium, carbon and the like, and copper is preferable. Examples of the form of the negative electrode collector are the form of a foil and the form of a mesh.
The negative electrode collector may be a structure in which a shock-absorbing layer, an elastic layer or a PTC (Positive Temperature Coefficient) thermistor layer is disposed on the surface of the collector.

### <Method of Manufacturing Solid-State Battery>

The method of manufacturing the solid-state battery relating to the present disclosure includes:
a step (preparation step) of preparing a positive electrode, a negative electrode, and an electrolyte layer or a separator; and
a step (layering step) of layering the positive electrode, the electrolyte layer or the separator, and the negative electrode in that order.

### (Preparation Step)

The preparation step is a step of preparing a positive electrode, a negative electrode, and an electrolyte layer or a separator.

The methods of fabricating the positive electrode, the negative electrode and the electrolyte layer are not particularly limited, and it is preferable that each is fabricated respectively by kneading components that can be contained in the above-described positive electrode layer, negative electrode layer or electrolyte layer so as to obtain a slurry, and coating the slurry on a substrate, and pressing a dried film that is obtained by drying the coated slurry.

The method of kneading the components that can be contained in the positive electrode layer at the time of obtaining the slurry is not particularly limited, and examples are a method of kneading by using a kneading device, or the like. Examples of the kneading device are an ultrasonic homogenizer, an agitator, a thin film revolving mixer, a dissolver, a homo mixer, a kneader, a roll mill, a sand mill, an attritor, a ball mill, a vibrator mill, and a high-speed impeller mill.

Examples of techniques of pressing the dried film are roll pressing, cold isostatic pressing (CIP), and the like.

The pressure at the time of pressing is preferably 0.1 t/cm² or more, and is more preferably 0.5 t/cm² or more, and is even more preferably 1 t/cm² or more. The pressure at the time of pressing is preferably 10 t/cm² or less, and is more preferably 8 t/cm² or less, and is even more preferably 6 t/cm² or less.

A commercially available porous sheet (film) can be used as the separator.

### (Layering Step)

The layering step is a step of layering the positive electrode, the electrolyte layer or the separator, and the negative electrode in that order.
In the layering step, it is preferable that the positive electrode, the electrolyte layer or the separator, and the negative electrode that were prepared in the preparation step are layered in that order, and a layered body (electrode body) is obtained by carrying out pressing as needed.

The solid-state battery relating to the present disclosure is preferably manufactured through the above-described steps.

### EXAMPLES

Examples are described hereinafter, but the present invention is not in any way limited to these Examples. Note that, in the following description, “parts” and “%” are all based on mass unless otherwise specified.

### Example 1

### [Preparation of Positive Electrode Active Material]

### (Step of Synthesizing Compound Expressed by Formula 2)

Mn(NO₃)₂·6H₂O, Ni(NO₃)₂·6H₂O, and Co(NO₃)₂·6H₂O as raw materials were dissolved in pure water such that the mol ratio of Mn, Ni and Co was 5:2:3. An Na₂CO₃ solution of a 12 mass % concentration was prepared, and these two solutions were simultaneously titrated into a beaker. At this time, the titration speed was controlled such that the pH became greater than or equal to 7.0 and less than 7.1. After completion of the titration, the mixed solution was stirred for 24 hours at 50° C. and 300 rpm. The obtained reaction product was washed with pure water, and only the precipitated powder was separated by centrifugal separation. The obtained powder was dried at 120° C. for 48 hours, and thereafter, was crushed in an agate mortar.
Na₂Co₃ was added to the obtained intermediate powder such that the composition ratio became Na_{0.75}Mn_{0.5}Ni_{0.2}Co_{0.3}O₂, and mixing was carried out. The mixed powder was pressed at a load of 2 tons by cold isostatic pressing, and pellets were prepared. The obtained pellets were preliminarily baked at 600° ° C. for 6 hours in atmosphere, and thereafter baked at 700° ° C. for 24 hours, and thereafter cooled at 3° C./min until reaching 250° C. and cooled-off. A compound (Na_{0.75}Mn_{0.5}Ni_{0.2}Co_{0.3}O₂) expressed by formula 2 was thereby synthesized.

### (Oxygen Vacancy Introducing Step)

The compound expressed by formula 2 that was synthesized by the above-described processes was maintained at 400° ° C. for 12 hours in a vacuum (1 Pa). Due thereto, oxygen vacancies were introduced, and an Na-doped precursor was obtained.

### (Ion Exchanging Step)

LiNO₃ and LiCl were mixed together in a mol ratio of 88:12, and a mixed powder was obtained. The mixed powder and the Na-doped precursor were weighed-out such that the ratio of the mol number of the Li contained in the mixed powder was 10 times the mol number of the Na-doped precursor. The Na-doped precursor and the mixed powder were mixed together, and ion exchange was carried out at 280° ° C. for 1 hour in atmosphere. After the ion exchanging, water was added and the salts were dissolved, and by carrying out water washing again, positive electrode active material 1 (Li_{0.68}Mn_{0.50}Ni_{0.20}Co_{0.30}O₂) having an O2-type structure was obtained.

### [Manufacturing of Solid-State Battery]

### (Preparation Step)

### —Preparation of Positive Electrode—

85 g of positive electrode active material 1 obtained by the above-described processes (which was a powder after having undergone a ball mill treatment) and 10 g of carbon black that is a conduction assistant were introduced into 125 mL of a solution of solvent n-methylpyrrolidone in which 5 g of polyvinylidene fluoride (PVDF) that is a binder was dissolved, and kneading was carried out until the components were mixed uniformly, and a slurry was prepared. This slurry was coated to a targeted amount of 6 mg/cm² on one surface of an Al positive electrode collector of a thickness of 15 μm that was the substrate, and was dried, and an electrode was thereby obtained. Thereafter, the electrode was pressed, and the thickness of the positive electrode layer was made to be 45 μm, and the density of the positive electrode layer was made to be 2.4 g/cm³. Finally, this electrode was cut so as to make the diameter 16 mm, and a positive electrode was obtained.

### —Preparation of Negative Electrode—

An Li foil was cut so as to make the diameter 19 mm, and a negative electrode was obtained.

### —Preparation of Separator—

A porous sheet made of PP was prepared as the separator.

### (Layering Step)

The positive electrode, the separator and the negative electrode were layered in that order, and a layered body was obtained. Note that the positive electrode was layered such that the positive electrode layer thereof faced the separator. The layered body and a non-aqueous electrolyte liquid (a liquid in which lithium hexafluorophosphate (LiPF₆) as a supporting salt was dissolved at a concentration of 1 mol/L in a mixture in which EC (ethylene carbonate) and DMC (dimethyl carbonate) were mixed together in a volume ratio of 3:7) were accommodated in a coin cell, and a CR 2032 type coin cell battery was manufactured.

### Example 2

### [Preparation of Positive Electrode Active Material]

A positive electrode active material was obtained by the same processes as in Example 1, except that, in the (Oxygen Vacancy Introducing Step), oxygen vacancies were introduced and an Na-doped precursor was obtained by maintaining a compound expressed by formula 2 at 400° ° C. for 12 hours in an atmosphere that was 95 vol % air and 5 vol % hydrogen. This positive electrode active material was positive electrode active material 2 (Li_{0.67}Mn_{0.50}Ni_{0.20}Co_{0.30}O₂).

### [Manufacturing of Solid-State Battery]

In the—Preparation of Positive Electrode—of the (Preparation Step), a coin cell battery was manufactured by the same processes as in Example 1 except that the positive electrode active material 1 was changed to the positive electrode active material 2.

### Example 3

### [Preparation of Positive Electrode Active Material]

### (Step of Directly Synthesizing Na-Doped Precursor)

Mn(NO₃)₂·6H₂O, Ni(NO₃)₂·6H₂O, Co(NO₃)₂·6H₂O, and Al(NO₃)₃·9H₂O as raw materials were dissolved in pure water such that the mol ratio of Mn, Ni, Co and Al was 5:2:2:1. An Na₂CO₃ solution of a 12 mass % concentration was prepared, and these two solutions were simultaneously titrated into a beaker. At this time, the titration speed was controlled such that the pH became greater than or equal to 7.0 and less than 7.1. After completion of the titration, the mixed solution was stirred for 24 hours at 50° ° C. and 300 rpm. The obtained reaction product was washed with pure water, and only the precipitated powder was separated by centrifugal separation. The obtained powder was dried at 120° C. for 48 hours, and thereafter, was crushed in an agate mortar.
Na₂CO₃ was added to the obtained intermediate powder such that the composition ratio became Na_{0.75}Mn_{0.50}Ni_{0.20}Co_{0.20}Al_{0.10}O₂, and mixing was carried out. The mixed powder was pressed at a load of 2 tons by cold isostatic pressing, and pellets were prepared. The obtained pellets were preliminarily baked at 600° C. for 6 hours in atmosphere, and thereafter baked at 700° ° C. for 24 hours, and thereafter cooled at 3° C./min until reaching 250° C. and cooled-off. A compound (Na_{0.71}Mn_{0.50}Ni_{0.20}Co_{0.20}Al_{0.10}O₂) expressed by formula 3 was thereby synthesized, and this was the Na-doped precursor.

### (Oxygen Vacancy Introducing Step)

The compound expressed by formula 3 that was synthesized by the above-described processes was maintained at 400° ° C. for 12 hours in a vacuum (1 Pa). Due thereto, oxygen vacancies were introduced, and the Na-doped precursor was obtained.

### (Ion Exchanging Step)

LiNO₃ and LiCl were mixed together in a mol ratio of 88:12, and a mixed powder was obtained. The mixed powder and the Na-doped precursor were weighed-out such that the ratio of the mol number of the Li contained in the mixed powder was 10 times the mol number of the Na-doped precursor. The Na-doped precursor and the mixed powder were mixed together, and ion exchange was carried out at 280° ° C. for 1 hour in atmosphere. After the ion exchanging, water was added and the salts were dissolved, and by carrying out water washing again, positive electrode active material 3 (Li_{0.67}Mn_{0.50}Ni_{0.20}Co_{0.20}Al_{0.10}O₂) having an O2-type structure was obtained.

### [Manufacturing of Solid-State Battery]

In the—Preparation of Positive Electrode—of the (Preparation Step), a coin cell battery was manufactured by the same processes as in Example 1 except that the positive electrode active material 1 was changed to the positive electrode active material 3.

### Example 4

### [Preparation of Positive Electrode Active Material]

Positive electrode active material 1 (Li_{0.68}Mn_{0.50}Ni_{0.20}Co_{0.30}O₂) was obtained by the same processes as in Example 1.

### [Manufacturing of Solid-State Battery]

In the—Preparation of Positive Electrode —, a coin cell battery was manufactured by the same processes as in Example 1 except that the added amount of positive electrode active material 1 was made to be 70 g, and the added amount of carbon black was made to be 25 g.

### Comparative Example 1

### [Preparation of Positive Electrode Active Material]

A positive electrode active material was obtained by the same processes as in Example 1, except that the (Oxygen Vacancy Introducing Step) was not carried out. This positive electrode active material was positive electrode active material C1 (Li_{0.68}Mn_{0.50}Ni_{0.20}Co_{0.30}O₂).

### [Manufacturing of Solid-State Battery]

In the—Preparation of Positive Electrode—of the (Preparation Step), a coin cell battery was manufactured by the same processes as in Example 1 except that positive electrode active material 1 was changed to positive electrode active material C1.

### <Evaluation>

### (Oxygen 1s X-Ray Photoelectron Spectroscopy Spectrum)

Oxygen 1s X-ray photoelectron spectroscopy spectra of the positive electrode active materials obtained in the respective examples were obtained in accordance with the above-described process. Among the obtained oxygen 1s X-ray photoelectron spectroscopy spectra, it was confirmed whether or not the spectrum had a peak in the region in which the binding energy is from 525 eV to less than 531 eV and in the region in which the binding energy is from 531 eV to 538 eV. Then, in a case in which there was a peak, the discharge photoelectron intensity at the peak top of that peak was determined.
The results are shown in Table 1. Cases, in which there is no peak in the region in which the binding energy is from 525 eV to less than 531 eV or in the region in which the binding energy is from 531 eV to 538 eV are listed as “no”, and cases in which there is a peak are listed as “yes”.
Further, in a case in which there is a peak, the discharge photoelectron intensity at the peak top of that peak is listed. Note that the discharge photoelectron intensity at a peak top existing in the region in which the binding energy is from 525 eV to less than 531 eV is “intensity Iₗₑ” in Table 1, and the discharge photoelectron intensity at a peak top existing in the region in which the binding energy is from 531 eV to 538 eV is “intensity Iₕₑ” in Table 1.

### (Kink Band Formation Proportion)

With respect to the batteries obtained in the respective examples, after the positive electrode was placed at a battery and discharging and charging were carried out, the proportion of the positive electrode active material at which kink bands were formed, with respect to the entire positive electrode active material, was calculated by the same process as in the above-described “. Process of Calculating Kink Band Formation Proportion”.
The results are shown in Table 1.

### (Initial Discharge Capacitance)

A charging/discharging test was carried out by using a galvanostat and under the conditions of current 0.1 C, charging end voltage 4.8 V, and discharging end voltage 2.0 V. Starting from charging, after a first instance of full charging was ended, the amount of current needed for discharging to 2.0 V was calculated. By dividing this value by the active material weight used in the measurement, the initial discharge capacitance was calculated.
(Capacitance Maintenance Rate after 20 Cycles)
A charging/discharging test was carried out under conditions similar to those described above, and the discharge capacitance of the first time and the discharge capacitance of the 20th time were calculated. The discharge capacitance of the 20th time was divided by the discharge capacitance of the first time, and the capacitance maintenance rate after 20 cycles was obtained.

TABLE 1

| | positive electrode active material | | | | | | | | | |
|---|---|---|---|---|---|---|---|---|---|---|
| | | oxygen 1 s X-ray photoelectron | | | | | positive electrode | | | |
| | | spectroscopy spectrum | | | | | | content | battery | |
| | | | | | | | | (mass | | capa- |
| | | region from | | region from | | | | %) | initial | citance |
| | | 525 eV to | | 531 eV | | | kink | of | discharge | main- |
| | | less than 531 eV | | to 538 eV | | intensity | formation | positive | capa- | tenance |
| | | absence/ | | absence/ | | Iₕₑ/ | pro- | electrode | citance | rate (%) |
| | | presence | intensity | presence | intensity | intensity | portion | active | (mAh/ | after |
| | battery | of peak | Iₗₑ | of peak | Iₕₑ | Iₗₑ | (%) | material | g) | 20 cycles |
| Exam- | Li_{0.67}Mn_{0.50}Ni_{0.20}Co_{0.30}O₂ | yes | 5618 | yes | 7542 | 1.34 | 15 | 85 | 201.4 | 97.6 |
| ple 1 | | | | | | | | | | |
| Exam- | Li_{0.67}Mn_{0.50}Ni_{0.20}Co_{0.30}O₂ | no | — | yes | 13215 | — | 24 | 85 | 200.5 | 97.8 |
| ple 2 | | | | | | | | | | |
| Exam- | Li_{0.67}Mn_{0.50}Ni_{0.20}Co_{0.20}Al_{0.10}O₂ | yes | 12451 | no | — | — | 12 | 85 | 205.6 | 98.1 |
| ple 3 | | | | | | | | | | |
| Exam- | Li_{0.67}Mn_{0.50}Ni_{0.20}Co_{0.30}O₂ | yes | 4715 | yes | 6820 | 1.45 | 10 | 70 | 207.8 | 93.2 |
| ple 4 | | | | | | | | | | |
| Com- | Li_{0.67}Mn_{0.50}Ni_{0.20}Co_{0.30}O₂ | yes | 11386 | no | — | — | 1 | 85 | 203.1 | 89.8 |
| parative | | | | | | | | | | |
| Exam- | | | | | | | | | | |
| ple 1 | | | | | | | | | | |

In Table 1, the “content (mass %) of positive electrode active material” is the content of the positive electrode active material with respect to the entire positive electrode layer.

From the above results, it can be understood that, with the positive electrode active materials and positive electrodes of the present Examples, there can be obtained batteries whose initial discharge capacitance is high and whose capacitance maintenance rate after discharging and charging are repeated is high.

What is claimed is:

1. A positive electrode active material at which an oxygen 1s X-ray photoelectron spectroscopy spectrum obtained by X-ray photoelectron spectroscopy measurement satisfies the following condition 1 or the following condition 2:
condition 1: a peak top does not exist in a region in which a binding energy is from 525 eV to less than 531 eV, and a peak top exists in a region in which the binding energy is from 531 eV to 538 eV; or
condition 2: a ratio of discharge photoelectron intensity Iₕₑ at a peak top, which exists in a region in which the binding energy is from 531 eV to 538 eV, with respect to discharge photoelectron intensity Iₗₑ at a peak top, which exists in a region in which the binding energy is from 525 eV to less than 531 eV, is 1 or more.

2. The positive electrode active material of claim 1, comprising a compound expressed by the following formula 1: 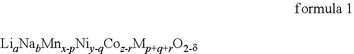
wherein, in formula 1, a, b, x, y, z, p, q, r and δ are numbers that satisfy 0≤ a≤1, 0≤b≤0.05, x+y+z=1, 0≤p+q+r≤0.20, and 0≤8≤0.3, and M represents at least one selected from the group consisting of B, Mg, Al, K, Ca, Ti, Cr, Ga, Zr, Nb, Mo and W.

3. The positive electrode active material of claim 2, wherein, in formula 1, M is Al.

4. A positive electrode, comprising:
a positive electrode layer containing a positive electrode active material; and
a positive electrode collector,
wherein, after the positive electrode is placed at a battery and discharging and charging are carried out, kink bands are formed in the positive electrode active material in 10% or more of the entire positive electrode active material.

5. The positive electrode of claim 4, wherein a content of the positive electrode active material is 70 mass % or more with respect to the entire positive electrode layer.

6. The positive electrode of claim 4, comprising the positive electrode active material of any one of claim 1 through claim 3.

7. A solid-state battery, comprising the positive electrode of claim 4.

8. A method of manufacturing a positive electrode active material, the method comprising:
heating a compound expressed by the following formula 2 at 400° ° C. or more and obtaining an Na-doped precursor, or obtaining an Na-doped precursor represented by the following formula 3; and
exchanging Na ions, which are contained in the Na-doped precursor, with Li ions: 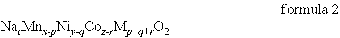
wherein, in formula 2, c, x, y, z, p, q and r are numbers satisfying 0.5≤c≤0.65, x+y+z=1 and 0≤ p+q+r≤0.20, and M represents at least one selected from the group consisting of Li, B, Mg, Al, K, Ca, Ti, Cr, Ga, Zr, Nb, Mo and W; and 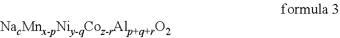
wherein, in formula 3, c, x, y, z, p, q and r are numbers satisfying 0.5≤ c≤0.65, x+y+z=1, and 0.05≤p+q+r≤0.20.
